(19) United States
(12) Patent Application Publication
(10) Pub. No.: US 2004/0083119 A1
(43) Pub. Date: Apr. 29, 2004

(54) System and method for implementing a vendor contract management system

(76) Inventors: Lawrence V. Schunder, Dallas, TX (US); W. Doyle Kitchen JR., Dallas, TX (US)

Correspondence Address: Rudolph J. Buchel, Jr., JONES DAY, P.O. Box 660623, Dallas, TX, 75266-0623, US

(21) Appl. No.: 10/656,415

(22) Filed: Sep. 4, 2003

Related U.S. Application Data
(60) Provisional application No. 60/408,466, filed on Sep. 4, 2002.

(51) Int. Cl. G06F 17/60

(52) U.S. Cl. 705/1; 705/7

(57) ABSTRACT

The present invention is directed to a system, method and software product for vendor contract management. The Vendor Contract Management (VCM) System is a web application used to track obligations, payments and fees under each vendor contract. The VCM system manages cash outflows. VCM interfaces with the digital images of the actual contract documents, which are linked to a database of the contract information and enterprise policy and rules information. The actual contract document images and their OCR-ed textual output are stored on a file server. That contract information may be used in event alert notification and financial prognosticating. The VCM process allows the user to perform maintenance tasks to a contract. After a new contract is added to the system, the user will use this process to make changes and updates to a specific contract. Additionally, the present invention is an integration application solution for local and remote scanning and indexing of documents. Its captures and transmits images over the Internet using XML documents and HTTP(S) to transmit through ISP and Corporate networks, enabling the remote scanning and index station (computer with a scanner) to be anywhere that has an Internet connection. The present inventions automation of OCR processing is also unique. The present invention then automatically schedules the image for processing and the OCR is done without the need for human intervention or participation and automatically indexes contract terms in the VCM database for conducting future searches.

### CROSS REFERENCES TO RELATED APPLICATIONS

The present application is related to and claims priority from U.S. Provisional Patent Application No. 60/408,466 entitled “SYSTEM AND METHOD FOR IMPLEMENTING A VENDOR CONTRACT MANAGEMENT SYSTEM,” and filed on Sep. 4, 2002, which is incorporated by reference herein in its entirety.

### BACKGROUND OF THE INVENTION

1. Field of the Invention

The present invention relates to document processing. More particularly, the present invention relates to a system, method and software program product for managing vendor contract documents.

2. Description of Related Art

The present invention is directed to a system, method and software product for managing vendor contracts for an organization. A typical enterprise necessarily engages in contracting with a variety of vendors, supplies and service providers. Many contracts entered into by the organization are self-perpetuating in that the contract automatically renews itself and the organization maintains its payments with the contracting vendor. Other contracts lapsed on a predetermined date specifies in the contract, and still others have fee acceleration clauses which automatically increase the fees paid due to the vendor based on the occurrence of some event, such as the anniversary date of the agreement. The enterprise usually is usually forced to implement some type of contract monitoring procedure to avoid any disruptions in supplies and services necessary for carrying out its mission.

On the other hand, businesses are often faced with an unwanted extension to a contract or automatic rate escalation merely because the organization did not opt out of a contract prior to it renewing under an automated renewal clause. It is conceivable that an organization could find itself paying fees to two different service vendors of similar products.

Generally, these situations come about because an organization simply does not have the resources to closely tract its vendor contracts. Moreover, most organizations hold the department managers responsible the maintenance for their respective department's contracts. This often leads to delegating the task to a less senior employee who is not as well versed with the contract terms as their managers. Additionally, the existence of the physical contract itself is often problematic for the organization. Businesses typically would rather keep the terms of their contracts confidential from other vendors, their competitors and even their own employees. Executed contracts are usually maintained in a secure location, usually centrally located facility, and away from those employees who are responsible for maintaining them. Duplicating is often discouraged so the responsible employee may be reduced to noting important contract event dates on a day planner. At best, key dates are annotated on an electronic event planner or calendar for a reminder.

Contract management products are known in the prior art but they typically comprise little more than a distributed date planner in which responsible parties in the organization can access for checking key dates. The contract is generally not accessible to the employee from the management system. Moreover, it is usually left up to the manager of the department to enter the contract parameters.

Prior art contract management systems are time consuming to use and not scalable. Even if a prior art management product were scalable, an organization would need to maintain a sufficient volume of contracts to justify cost and training. Prior art contract management systems do not afford the user with the tools for searching and the organization's contracts by the contents of the contracts. Usually, someone must devote the time necessary to manually search all of the contracts for important terms, conditions and concepts. At best, an organization may have an electronic version of its contracts available for viewing on its private LAN. Also, prior art contract management systems simply did not support contract search tools, indexing and therefore, textual versions of the contract documents were simply not necessary.

Previous scanning and indexing systems could not operate over the Internet as an integrated application. The programs had to first scan the document and then send the document via email or FTP to a server. With ISP's and corporations using routers and firewalls to block protocols and also implementing limitations to the size of emails, this sometimes became impossible. Once the user did get the image to the server they then had to either use a browser or VPN into the corporate LAN to index and move the image to its final storage area.

Previous OCR solutions were implemented at the client. This required that all users were trained to use the OCR component and be able to “clean up” documents. The “clean up” process is extremely laborious because the entire document must be check for OCR translation errors. This can take from minutes to hours on contracts. The size of the contract and the quality of the scanned image determines this.

The implementation of OCR translation and “clean up” also required that a second file be downloaded to the host server. In summary, previous implementations that provided processing at the client dramatically increased the time it takes to process a document and encountered technical difficulties in transferring the documents to their host and increased the cost per document due to OCR processing costs at each client.

### SUMMARY OF THE INVENTION

The present invention is directed to a system, method and software product for contract management. The Vendor Contract Management (VCM) System is a web application used to track obligations, payments and fees under each vendor contract. The main purpose of the system is to manage cash outflows. VCM interfaces with the digital images of the actual contract documents, which are linked to a database of the contract information and enterprise policy and rules information. The actual contract document images and their OCR-ed textual output are stored on a file server. That contract information may be used in event alert notification and financial prognosticating. Another aspect of the VCM System is that is provides a schedule of expected payments due by fiscal period that can be matched to vendor invoices are received. Also, the VCM system provides a forecast of payments due based on actual contract obligations and “what if” scenarios, such as selected contract renewals. The VCM process allows the user to perform maintenance tasks to a contract. After a new contract is added to the system, the user will use this process to make changes and updates to a specific contract. New documents can be scanned and linked to the contract information. The actual contracts, purchase agreements, letters and/or amendments are scanned into digital format and placed on the server. All scanned documents will link to the information of the contract in the database. At several points in the VCM System there is an interface with the server in order to view or add scanned documents related to specific contracts. The VCM system also supports a calculation process. Contracts and schedules that are entered into the system server as parameter values in order to calculate expected payments for specified fiscal period. The calculation process utilizes the parameter values to generate a schedule of expected payments for all active contracts. The calculations process may be invoked on demand, by a scheduler, or even as part of the “what if” scenario calculations. The user may also set “What if” scenarios based on changes to parameters such as datelines, contract increases, delay of payments, etc. This function will allow the user to do forecasts on payments, and see how the cash outflow varies according to the different scenarios. The results of the “what-if” scenarios are displayed to show the expected payment schedules, contract information, vendor information, forecast of payments etc.

Additionally, the present invention is an integration application solution for local and remote scanning and indexing of documents. Its uniqueness lies in the method of capture and transmission of images over the Internet. The present invention utilizes XML and HTTP to transmit through ISP and Corporate networks, enabling the remote scanning and index station (computer with a scanner) to be anywhere that has an Internet connection. The ability to implement the standard HTTP(S) protocol instead of FTP provides the present invention with compatibility from corporate to corporate or ISP to corporate, connections.

The presently described invention employs an automated OCR processing and indexing process for the near-simultaneous converting of image data to textual data, and indexing the textual data for searching. Once the image is captured by the host computer parameters and organization configuration is checked to determine if OCR processing is required. The user for a specific document can also request OCR processing whereas the organization default is to not OCR documents. The present invention then automatically schedules the image for processing and the OCR is done without the need for human intervention or participation. This decreases the time it takes to fully process a document and increases the number of document that a person can process. The text of the OCR-ed document is immediate indexed during OCR-ing. Trained personnel accomplish the OCR “clean up” process at a central location. This enables the user to be more effective in scanning and indexing documents, and enables them set contract dates, actions and contract schedules.

### BRIEF DESCRIPTION OF THE DRAWINGS

The novel features believed characteristic of the present invention are set forth in the appended claims. However, the invention itself, as well as a preferred mode of use, further objectives and advantages thereof, will be best understood by reference to the following detailed description of an illustrative embodiment when read in conjunction with the accompanying drawings wherein:

FIG. 1 is a diagram depicting the logical representation of the VCM components in accordance with an exemplary embodiment of the present invention;

FIG. 2 is a network diagram of an exemplary VCM network in accordance with an exemplary embodiment of the present invention;

FIG. 3 is a flowchart depicting a generic VCM management process in accordance with an exemplary embodiment of the present invention;

FIG. 4 is a flowchart depicting an overview of a method for managing contracts in accordance with an exemplary embodiment of the present invention and as implemented in the VCM system;

FIGS. 5A and 5B are flowcharts of a method for managing vendor contracts in accordance with an exemplary embodiment of the present invention;

FIG. 6 is a flowchart depicting a vendor contract management event alert processing method in accordance with an exemplary embodiment of the present invention;

FIG. 7 is a flowchart depicting a vendor contract management optical character recognition and indexing method in accordance with an exemplary embodiment of the present invention;

FIG. 8 is a flowchart depicting the indexing and updating methodology employed by the VCM database index engine in accordance with an exemplary embodiment of the present invention;

FIG. 9 is a flowchart depicting a vendor contract management calculations method for generating a list is scheduled expected payments for a given fiscal period in accordance with an exemplary embodiment of the present invention; and

FIG. 10 is a diagram depicting the relationships between VCM entities in accordance with an exemplary embodiment of the present invention.

Other features of the present invention will be apparent from the accompanying drawings and from the following detailed description.

### DETAILED DESCRIPTION OF THE INVENTION

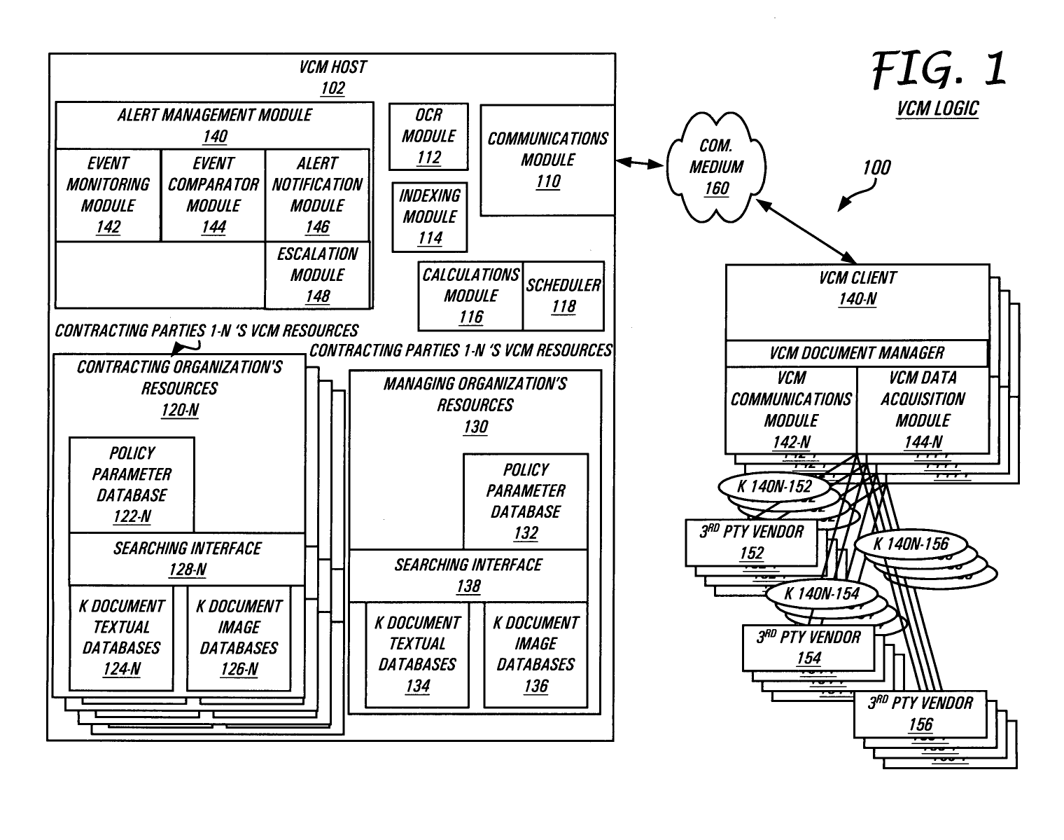

The present invention describes a Vendor Contract Maintenance System (VCM) for managing contracts between an organization and third-party vendors in accordance with the exemplary embodiment of the present invention. FIG. 1 is a diagram depicting a logical representation of the VCM components in accordance with an exemplary embodiment of the present invention. From the present figure, it should be apparent that the majority of the active VCM compounds reside on a VCM host or server, shown in the figure as VCM host 102. VCM host 102 generally comprises two separate types of components: active components for executing instructional code and processing data, and organizational resources. The active components of VCM 102 include communications module 110, OCR module 112, indexing module 114, calculation module 116, scheduler 118 and alert management module 140 for processing and managing data relating to third-party vendor contracts. Additionally, VCM host 102 also comprises a group of resources each of which are specific to or are owned by a specific organization. These resources can be allocated or accessed only by the owner organization. Generally, each organization serviced by VCM host 102 has at its disposal a plurality of databases resources for holding policy parameters, third-party contract documents, as document images and textual documents. As depicted in the figure, these include the VCM owning organization's resources 130, and other resources for supporting organizations which contract for VCM services from the VCM owner. As can be appreciated from the diagram, an organization may implement the VCM system for managing its own contracts, or may instead, or in addition, utilize the VCM system for providing a contract management service to other organizations as a fee-based service. The resources for those contracting organizations are depicted in the figures as contracting organization's resources 120-1 to 120-N, associated organizations 1 through N. Also shown in each respective organization's resources are policy parameter database 122 and 133, contract document textual databases 124 and 134, and contract document image databases 126 and 136. Also included among each of the organizational resources is a searching interface, such as searching interface 128 and 138 which enable authorized users associated with a specific organization to search the databases for that organization.

Also shown in FIG. 1 is a plurality of VCM clients, each of which communicate with VCM host 102 by means of communications medium 160 which may be any of an intranet, LAN, WAN, Internet, PSTN or any other type of network capable of transmitting information. Each of VCM clients 140-1 to 140-N include two VCM components which are passed to a VCM client in response to a user initiating VCM service at that client (assuming, of course, that VCM components are not residents on time). These VCM components include VCM communications module 142 and VCM data acquisition module 144, referred to alternatively herein as the VCM document manager module. As a practical matter, VCM communications module 142 and VCM data acquisition module 144 may be implemented as a single module of mobile code, executable on a web browser application operating thereon. Those of ordinary skill in the art would readily recognize the applicability of certain distributed operating environments capable of supporting self-sufficient programs which may be run anywhere in that operating environment network. Examples of such environments include ActiveX controls (trademarked by and available from the Microsoft Corporation, Redmond, Wash.) or Java technologies platforms (trademarked by and available from Sun Microsystems, Inc., Santa Clara, Calif.).

Here should be understood that each of clients 140-1 to 140-N belong to a particular organization, and that organization will, from time to time, form agreements or contracts with third-party vendors such as vendors 152 through 156. These contracts are represented in the diagram as contracts as K 140N-152, K 140N-154 and K 140N-156 between client 140-N and vendors 152, 154, and 156. As will be understood from the following description, each time an organization enters into a contract with the third-party vendor through one of its clients, the contract information is passed to VCM host 102 for processing and management.

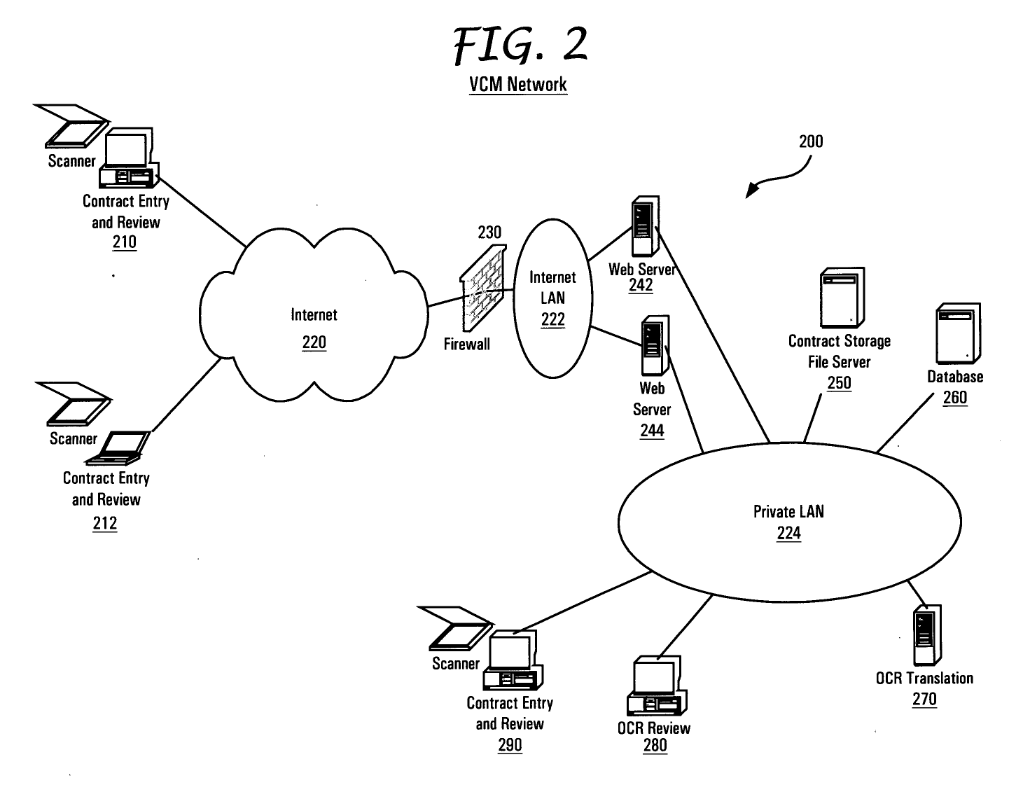

Turning now to FIG. 2, VCM network 200 is depicted therein and includes exemplary hardware components for each of the logical components described above in FIG. 1. Beginning at the client side, VCM network 200 includes contract entry and review clients 210 and 212. Notice that each of clients 210 comprises a data processing system capable of entering contract data which also included a peripheral scanning device for imaging documents. Also notice that finds 210, and 212 are connected to VCM web servers 242 and 244 via Internet 220, firewall 230, and Internet LAN 222. Here it should be understood that the specific network configuration depicted in the present figure is merely exemplary and not intended as the only network configuration for implementing the VCM system. It should, however, be understood that VCM host security is of primary concern and therefore steps should be implemented for isolating VCM host, and/or the VCM host LAN, from outside intrusion. Prior to the previously described VCM system, it was not possible to provide security for the VCM host while simultaneously allowing for unfettered access to the host by the VCM clients. Essentially, the logical components depicted in VCM host 102 of FIG. 1 are shown in FIG. 2 connected to LAN 224. These include web servers 242 and 244, database 260, OCR translator 270, OCR review 280, contract entering review device 290 and contract storage file server 250. Here it should be mentioned that each of contract entering review devices 210, 220 and 290 may be implemented as a browser application on a computer with an ActiveX component which interfaces with the scanning device attached to the computer. This component provides instructions for scanning the page or document in accordance with the VCM process methodology.

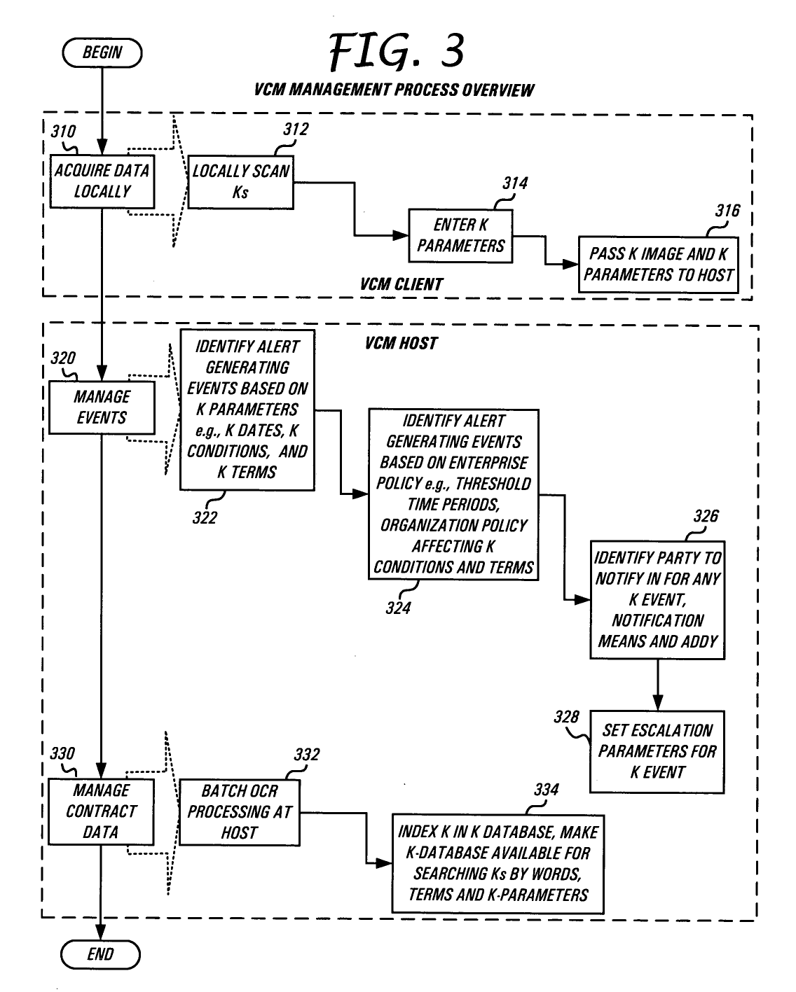

As mentioned above, a function of the VCM system is for the management of contracts and contract-related events associated with an enterprise. The VCM system may be defined as providing plurality of contract management functions to an organization. These functions include: the acquisition of contract data; the establishment of alerts; translating image documents into textual documents for subsequent indexing and searching operations; and . FIG. 3 is a flowchart depicting a generic VCM management process in accordance with an exemplary embodiment of present invention. At a high level, the VCM management process may be divided into three tasks: contract data acquisition; event management and alert notification; and contract data management, indexing and searching. The generic vendor contract management process begins by acquiring contract data (step 310). Typically, the contract data are acquired remotely from the VCM host at one of the VCM clients. However, as a practical matter contract data may be acquired at any network node having the capability to receive and execute VCM components, and to enter contract parameter values and image data. For purposes of describing the present invention, contract data takes the form of at least contract image documents and internal contract parametric information. Typically, a contract is drafted between two contracting parties (e.g., an organization and a third-party vendor). However, contracts are often the preprinted variety with blank spaces for contract information such as the identity of one of the contracting parties, implementation date, termination date, etc. In still other cases, an unexecuted contract may be electronically transmitted to one of the parties for signatures. In, that case, an unexecuted version of the contract may be available in electronic form, such as in the PDF file or as a DOC file. Nevertheless, the executed version of a contract will generally be available only as a paper document. The two types of contract data may be acquired in any order. However, in accordance with the present flowchart, the contract document image information is initially acquired by locally scanning the executed contract document at the client (step 312). The document may be transformed using any type of imaging format, such as BMP, GIF, TIF, TIFF, PCX, and XBM, or any fax format, such as, AWD, CG4, FAX, PCX and WFX, but it should be remembered that the document image will ultimately be translated into character code (e.g., optically character recognized (OCR)). Therefore, the choice of imaging format should allow for the creation of lossless high-resolution, grayscale images from physical contract documents. However, it should also be remembered that if an unexecuted version of the contract is available in electronic form, it may also be used as described below. Contract parameter values, on the other hand, are manually extracted from the contract document contents and the extracted contract parameter values are then entered by the user at a VCM client (step 314). Simultaneously, the user can review the contract parameter values being interred at a VCM client for accuracy. Finally, with the image and contract parameter data stored in the VCM client, the VCM client can then pass the data onto the VCM host (step 316).

Once the contract data are passed to the VCM system, the tasks of the VCM client(s) are completed and the VCM host takes sole control of the contract management process. Of primary concern to any organization which enters into contracts with third parties, for instance with third-party vendors, is the maintenance of the contract terms and conditions as negotiated. This is accomplished by implementing the present VCM system for invoking a contract event alert management process. Before further describing the event alert management process of the present invention, it may be helpful to define some relevant terms which are used herein to describe the VCM management process. An event is defined herein as an occurrence, or happening, associated with or relating to a term or condition of a contract. The VCM host monitors its environment for events. As will be discussed in greater detail below, upon perceiving an event, the VCM process identifies all contracts with terms or conditions relating to the event, and then identifies any of those contracts which may need attention by a party responsible for the contract (i.e., the responsible party being a person in the contracting organization whose duty it is to oversee some aspects of the contract, but in any case, is the contact person for the VCM alert notification process). An event alert is generated for any contract(s) which the VCM process determines there may be in need of maintenance by a responsible party. Essentially, the event alert notification to the responsible party affords the contracting organization with the opportunity to carry out any contract maintenance in view of the event prior to the occurrence of the contract condition (e.g., such as the contract lapsing, fees increase, etc.). An event alert is typically a notification sent by the VCM to a contact person in the organization who is responsible for either maintaining the entire contract or at least maintaining the contract parameter relating to the event, or both. A contract parameter is defined herein as relating to some aspects of the contract. Event alerts are not generic to the contract, but instead are specifically structured based on the term(s) or condition(s) contained in an identified contract which the VCM determines corresponds to the contract event. Thus, the VCM system will generate different types of event alert notification depending on the type of event and its context within the contract. A contract parameter value corresponding to the contract event, is then accessed from the contract and compared to the event itself. The event alert is then sent, or not, based on the outcome of that comparison. While it may be possible for the VCM to correctly access the text of a contract to ascertain contract parametric values, in accordance with an exemplary embodiment of the present invention, contract parameters and their corresponding contract parameter values are manually entered into the VCM process for extraction by the VCM event management process. As will be understood from the examples described below, contract parameter values are held into a tabular structure by the VCM. An event alert may also be generated as a result of the VCM comparing the event to organizational rules and/or policies pertaining to the subject matter of the contract, or the identity of the third-party vendor that has contracted with the organization, or even rules relating to the past history of interaction between the organization and the third-party contractee. In a similar fashion as described above for the contract parameter values, organizational rule and/or policy values are also organized in a tabular structure for reference by the VCM event alert process. As a general proposition, the VCM spawns an event alert notification only in situations in which some type of proactive contract maintenance may be required by the organization owning the contract.

In accordance with an exemplary embodiment of the present invention, managing contract events involves identifying contract events and then ascertaining alert generating events, whether the events are based on a contract parameter of the organization's rules and policies; then, identifying responsible parties associated with the event alert; and finally, if an acknowledgment is not forthcoming from the responsible party, implementing an escalation protocol for insuring that a contact person in the organization is notified with the event alert information.

Returning now to FIG. 3, the VCM host manages all contract related events (step 320). Managing events involves identifying any alert generating event(s) based on terms or conditions specified in the contract (step 322). Contract terms and conditions are generally referred to herein as the contract parameters. Exemplary contract parameters include such contractual terms as the identities of contracting parties, contract obligations, rates, prices, performance, escalation clauses, licensing information, renewal dates, etc. A contract parameter merely relates to a type of event. The occurrence of a particular type of event, even while specified by a contract parameter, may not necessarily generate an alert of the notification. Instead, it is the parametric value associated with a specific contract parameter which causes the generation of alerts to a responsible party in an organization. The parametric value is a data value associated with a specific contract parameter. Taken in the context of a data structure, a contract parameter corresponds to an entry field, while the parametric value corresponds to the data entered in a particular parametric field. For example, $2,321.00 may be a contract parametric value associated with a contract fee parameter, or Dec. 31, 2004 may be a contract parametric value associated with a contract license renewal date parameter. In any case, once all alert generating events are identified in the contract and their corresponding parametric values are entered in the VCM process, a second type of alert generating events are identified and entered into the VCM process. This second type of alert generating events is based on specific policy implemented by an organization based on the needs of that particular organization (step 324). Here it should be understood that merely because a contract defines a specific parametric value, an alert may not be generated solely on the occurrence of an event which corresponds to that value. The organization may instead implement policy values which override the contract parametric values. For example, if a renewal date for a software license contract is Dec. 31, 2004, the responsible party within the organization must determine whether or not to renew the software license prior to the actual renewal date specified in the contract (i.e., Dec. 31, 2004). Therefore, the organization may set as in internal policy value (an organizational policy parameter value) a three-month buffer time period in which to alert the responsible party. With regard to the example above, the VCM management process would alert the responsible party in the organization of the renewal date event on Sep. 30, 2004 based on the occurrence of an organizational policy event, rather than waiting for the contract renewal event date of Dec. 31, 2004.

In addition to every contract parameter having a parametric value associated with it, the identity of the responsible party within the contracting organization for that aspect of the contract is also likewise associated with the contract parameter in the VCM system (step 326). The VCM system also maintains contact information for notifying the responsible party in case of an event occurrence. This contact information may be virtually any form depending on the communications medium (e.g., a PSTN telephone number for communicating over a PSTN network, a mobile telephone number for communicating over a cellular network, an e-mail address for communicating over information network such as the Internet, or all the above). Depending on a number of factors, including the complexity of contract, more than one person within an organization may be designated as a responsible party for a contract parameter by the VCM. For example, upon the termination of the occurrence of a licensing renewal contract event by the VCM system, the VCM will typically alert a manager of the division within the organization (or some other responsible person) which utilizes the particular software application. Additionally, the organization may designate other parties for notification such as the organization's attorney, ITT coordinator, a corporate officer, an organizational task team formed for evaluating the particular software application, etc.

In any case, the VCM will expect an acknowledgment to be returned by the responsible party in response to the event alert notification. Should the VCM not receive the acknowledgement, the escalation process, which is established for an organization as a means for dealing with contract events as the time period for handling them become shorter, is invoked (step 328). Essentially, the escalation process notifies the supervisor of each responsible party that the party has not acknowledged an event alert issued by the VCM. Thus, the escalation process database is structured similar to that of the responsible party notification database, in that the parties to be notified are identified, along with their contact information. However, in addition to the contact notification information, the escalation process also defines the escalation notification hierarchy, including a response time period for each node in the hierarchy to acknowledge an escalation notification.

Generally, it is expected that once a contract is acquired (step 310), the VCM event management process will be immediately implemented (step 320) to ensure the contract events can be monitored by the VCM and immediately correlated to contracts under its control. The final step in the VCM process is the management of all contract data, including indexing the contract data in such a manner that the entire contract may be searched by pertinent information other than that designated as contract parameters (step 330). Thus, initially the contract document image should be translated into character code (e.g., optically character recognized (OCR)) (step 332). OCR-ing the contract documents at the VCM host allows the VCM system to take advantage of economies of scale and pooled expertise. Rather than OCR-ing documents at the VCM client, where users are far less experienced with OCR applications and have less time and inclination for proofing OCR-generated documents, OCR-ing tasks are relegated to a group of dedicated individuals at the host site wherein groups of contracts can be batch OCR-ed in an assembly-line-like fashion. However, as mentioned above, some contracts may also exist in an electronic code version as well as an image document. It should be recognized, however, that if a code version of a contract document exists, it is probably an unexecuted version and not the final executed version. That document may be executed without substantive changes to the document, but occasionally a contract will receive last minute changes just prior to execution. The image version of the contract may contain substantive changes from that of the code version. Therefore, care must be taken to ensure that if a code version of the contract document is used in the VCM, it is identical to the final image version of the executed contract document. At any rate, it is not expected that it will be necessary for the VCM process to utilize unexecuted electronic versions of contract documents other than those created internally by the VCM itself from the image contract document.

Regardless of how the character code contract document is created, it is then indexed and stored in a textual contract database and made available for term, index, contract parameter and contract parameter value searches (step 334). The general VCM management process then ends.

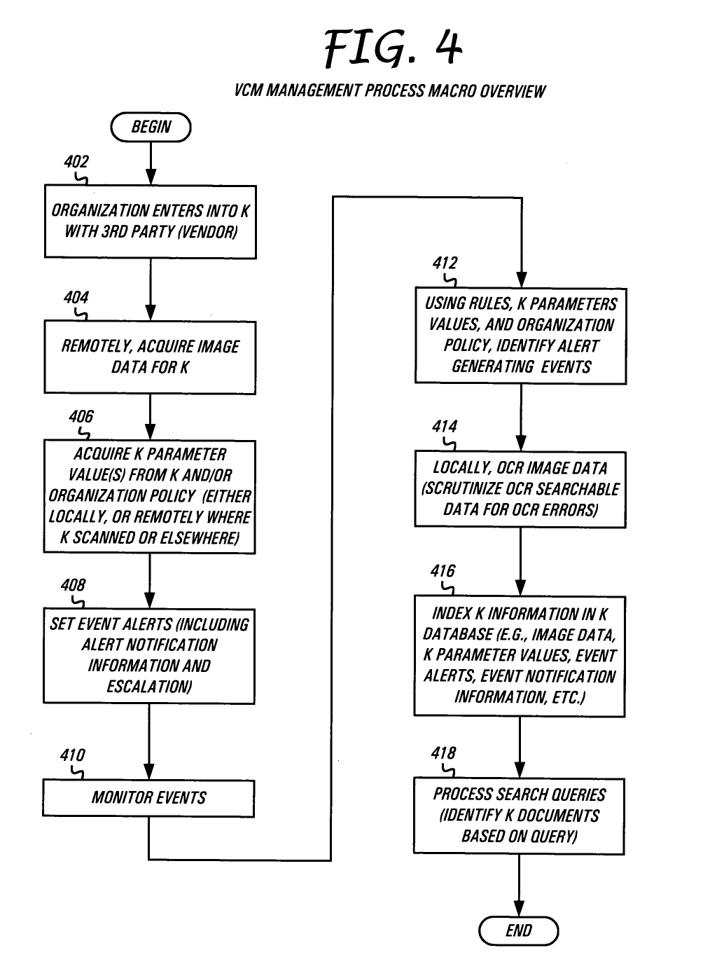

FIG. 4 is a flowchart depicting an overview of a method for managing contracts in accordance with an exemplary embodiment of the present invention and as implemented in the VCM system. Process begins with an organization entering into a contract with another party (step 402). As used herein, the party contracting with the organization is referred to as a third-party; however, this nomenclature is appropriate only in cases where contract management is provided as a service to the contracting organization. In those cases, the VCM service provider-organization is generally not a party to the contract. Regardless, once an organization enters into a contract, the contract data must be acquired for the VCM process. Initially, contract document image data is acquired (step 404). The contract document image data is generally acquired by the organization contracting with the third-party vendor, but here again, that organization may either own the VCM system or might instead procure the VCM management services from the VCM owner-organization. Next, the contract parameter values are parsed from the contents of the contract (step 406). Additionally, organizational policies and/or rules are acquired for implementation by the VCM process. It is expected that organization policy and rules data will be acquired and entered into the VCM databases only once and therefore it is not necessary to re-enter organizational policy information for each contract being acquired by the VCM system. However, it is expected that policy and rules updates may be made to the organizational policy data from time to time, and it may in fact be necessary to update the policy data on a contract-by-contract basis. With the contract data, contract parameter data, and organizational policy data entered in the VCM system, event alerts may be selected for the contract (step 408). Alert notification data, such as the identities and notification information for responsible parties, are also entered in the VCM system along with escalation protocol information. The escalation protocol is simply a means by which the VCM ensures that someone in the organization is notified if the responsible party does not acknowledge receipt of the alert notification. Typically, escalation protocol is based on the management hierarchy of the responsible party (i.e., if the responsible party does not acknowledge receiving the event alert, then the VCM transmits another event alert notification to the responsible party's supervisor, then to the supervisor's supervisor and so on).

At this point, the VCM process can begin monitoring events for the contract (step 410). With each event, the VCM process compares the event to contract parameters, contract parameter values and organizational policy values for all of the contracts managed by the system. Using internal event comparison rules, the VCM identifies alert generating events for a specific contract (step 412). The VCM sends alert notifications to responsible parties for the contract and then waits for an acknowledgment from the recipient. If none are forthcoming, the VCM escalates the notification process up to the escalation notification protocol as necessary until an appropriate acknowledgement is received by a contact person higher up in the escalation hierarchy.

The context of the contract document can now be converted to textual code (code characters) for storage in a textual database (step 414). Character conversion is accomplished using optical character recognized (OCR) as described above. The OCR-ed data is carefully compared to the source image contract document for accuracy and any character errors corrected in the document prior to storage. Next, the textual contract information is indexed in the VCM system databases based on different indexing criteria, for instance by contract parameters, contract parameter values, event alerts, alert notification information, etc. (step 416). The contract data (i.e., image, textual, contract parameters, parameter values, alert criteria, notification, etc.) is then stored in the VCM database resource for the owner organization, and referenced to the indexing information. With the contract information available in the VCM databases, the VCM process searches for requests from authorized users for an organization (step 418). The generic vendor contract management process continues iteratively, as described above, each time a new contract is acquired.

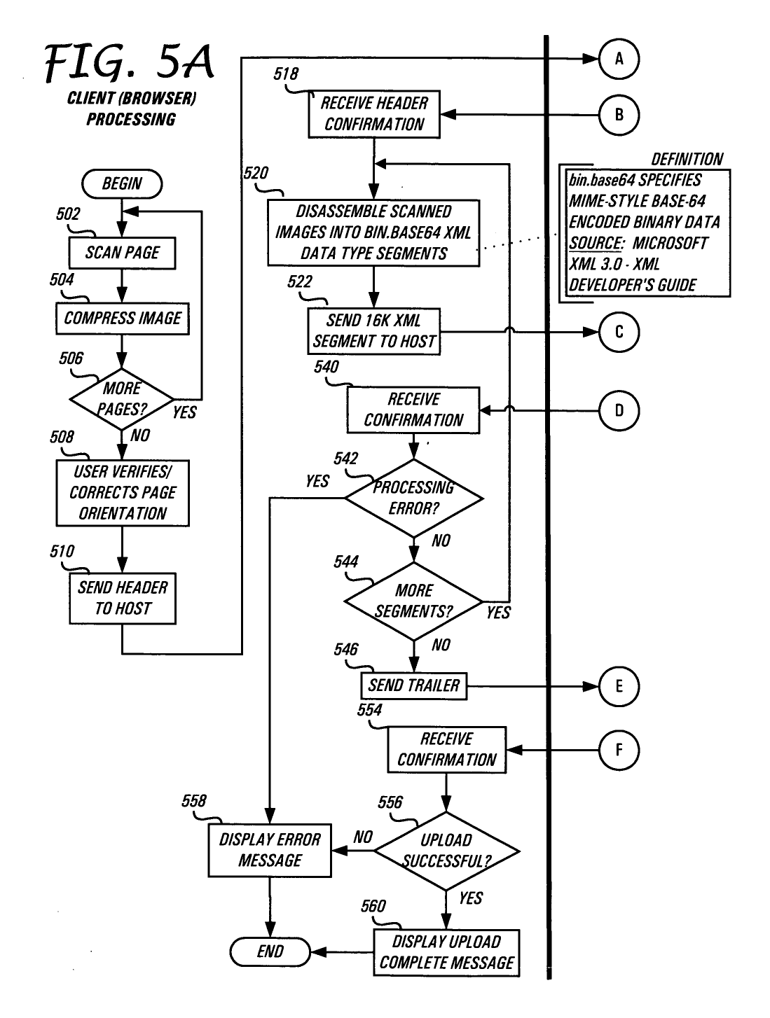

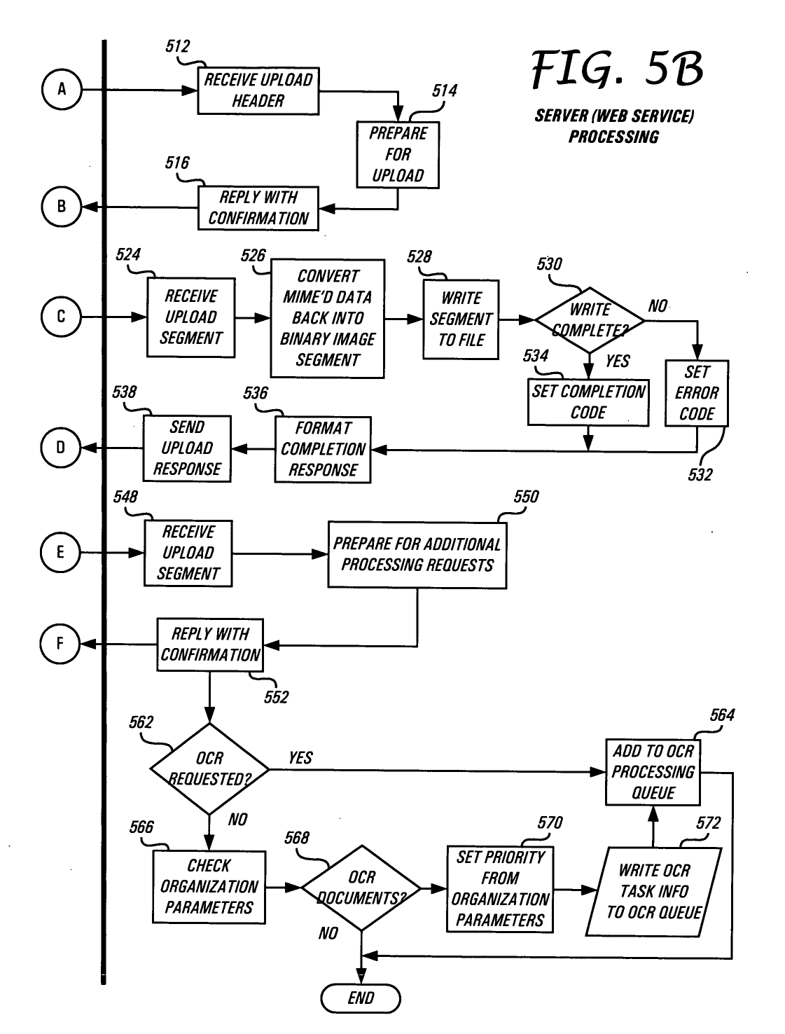

FIGS. 5A and 5B are a flowchart of a method for managing vendor contracts in accordance with an exemplary embodiment of the present invention. The presently described method illustrates the steps for acquiring an image, transferring it to a server and then to automated OCR processing. FIG. 5A depicts a portion of the contract management method executed at a remote client location, while FIG. 5B depicts a portion of the method performed at the local host location. The contract management process embodied in the present invention is extremely flexible and may be adaptably configured to virtually any information network. However, the exemplary embodiments of the present invention are described in particular detail with respect to a TCP IP (Internet protocol) compliant network, which is not intended to limit the scope of the present invention or its application network. Therefore, the VCM client may be any appliance capable of transacting on information network and supporting a browsing application. The VCM host, on the other hand, may be any network appliance capable of transacting with a plurality of network devices and supporting the VCM host components and resources. Those of ordinary skill in the relevant art would readily understand that the entire VCM process may be supported on consumer and/or commercial off-the-shelf products (COTS).

The end user of the VCM process application initiates the VCM program modules on the VCM client by running the Web browser application, such as Internet Explorer (trademarked by and available from the Microsoft Corporation) or Netscape (trademarked by and available from the Netscape Communications Corp., Mountain View, Calif.). The user then links to the VCM site for the user's organization by typing the URL address of that web site in the address line of the browser.

The user will log in to the VCM host system and select the Contract Maintenance screen for adding a contract. At this point, the user identifies the contract document and enters contract parameter values for following contract parameter fields:

| Contract Document | |
|---|---|
| Parameter | Action/Contract Parameter Value |
| Organization | The corporate entity monitoring the contract. |
| Department | The department within the selected Organization to |
| | which the contract belongs. |
| Contract Number | This provides a document ID, alpha and numeric, |
| | by which the contract can be identified. The |
| | user/organization can establish their structure to this |
| | field. This must be a unique value for the |
| | Organization. |
| Type | A pre-configured contract type field. The user will |
| | select from previously defined contract types set up |
| | for the organization. |
| Term | This field is for the contract term. The user enters a |
| | numeric term and then selects days, months or years |
| | from the period type. |
| Manager | The user selects the manager that will administrate |
| | this contract. The managers for the organization |
| | have previously been entered so the user need only |
| | to select the appropriate one. |
| Vendor | The Vendor for this contract which could be either |
| | the organization or another company defined in the |
| | system as a vendor. |
| Entities | These are other companies or departments of |
| | companies that are associated with the contract. |
| Master/Sub Contract | The user selects a Master contract if this contract is |
| | a sub-contract. |
| Contract Dates | The user adds all pertinent dates associated with the |
| | contract. (e.g., Start Date, End Date, Review Date, |
| | Renew Date, etc.). |

Once the contract has been defined, the user will click on the “add” button to finish the “add” process. The user is now ready to scan the contract into the system. The user will select the “Documents” menu item. This screen allows the user to define and scan documents associated with the contract. The user must then define the document that is to be scanned. Since there can be multiple documents associated with the contract, the user will identify each document:

| Contract Document | |
|---|---|
| Scanning Parameter | Action/Contract Parameter Value |
| Document Type | The user selects a pre-defined document type which |
| | could be an amendment, a contract, an exhibit or |
| | other documents that the user wants to associate |
| | with the contract. |
| Description | The user enters a brief description of the document. |
| Notes | The user enters notations which further identify the |
| | document and its contents. |
| Index Fields | These are optional. The user enters specific indexes |
| | for the document based upon pre-defined index |
| | fields. |
| Effective Date | The effective date of this document. |

The VCM process begins by the client scanning the contract documents. Here it should be understood that neither the VCM communications module or the VCM data acquisition module are native to a Web browser; therefore, VCM host will, upon receiving a request from the client, pass the necessary executable VCM code to the client Web browser. The distributable, executable code may be in the form of an ActiveX module, or control, (trademarked by and available from the Microsoft Corporation in Redmond, Wash.), or it may also be implemented as other types of mobile executable code, such as a Java applet (trademarked by and available from the Sun Microsystems, Inc., Santa Clara, Calif.). The VCM communications module or VCM data acquisition module, referred to alternatively as VCM Document Manager, is loaded when the user clicks the “on” button to scan the document. The VCM Document Manager will signal the attached scanner (a scanner physically attached to the computer via a SCSI or USB or other cabling method) to begin scanning. This is accomplished by activating a DLL from several imaging providers that the VCM Document Manager can interface with to provide commands, such as a location to place the images on the local disk drive and image manipulation features (rotate image, enlarge, reduce, etc.)

Returning now to FIG. 5A, when the VCM document manager is installed on the client, the user may begin scanning pages of the contract document (step 502). It is assumed that a contract document consists of any number of pages; however, once scanned the image pages will be sequentially ordered and stored in a single data file. After each page of the contract document is scanned, the outputted image data is compressed (step 504). A scanner manufacturer will typically provide some type of image compression algorithm with a scanner's operation software. However, the image compression feature described above is a function of the mobile executable code downloaded to the client and not a typical OEM compression algorithm. The compression algorithm reduces the size of the transfer to be made to the host server.

One advantage of the presently described contract management method is that large image files can be transmitted through secure firewalls without modifying the firewalls, thereby inviting security breaches. It is well understood that bulky data files can be transmitted using such techniques as the File Transfer Protocol (FTP) for exchanging files between clients and host over the Internet. However, firewalls protecting the host network usually require some modifications for the FTP file transfers. Each modification to the firewall presents another avenue for a potential hacker to breach security provided by the firewall. Moreover, FTP transfers data to a continuous datastream which impedes the flow of other data to the network boundary server and thereby lowers the effective bandwidth to the organization's private LAN. In contrast, the present invention utilizes a variant of the Extensible Markup Language (XML) for sharing information in small manageable packets of information. Thus, rather than creating a security work-around in the firewall for supporting the transport of large image files, file (and network) security is embedded in the data type selected for transporting the image data. The firewall remains intact and the image data passes through the firewall as verifiably secured packets of data.

Returning now to FIG. 5A, the user is prompted for more document pages (step 506). If more pages are to be scanned, the process iterates from steps 502 to 506 until the entire contract document is completely converted to image data. Once the pages of the document are scanned, the user can review the document images and manipulate them so they are right side up for best viewing. The VCM process then prompts the user to inspect the document (step 508) to verify that the contract document image pages contain the entire text of the document and are oriented in the proper direction. If the pages are not properly oriented, the user is prompted to adjust the orientation of the pages or to rescan the document or the pages. The physical contract document will be stored separately from the electronic versions created by the VCM process. Therefore, any errors in the image data should be rectified while the physical contract document is available. Furthermore, any subsequent OCR processing will be performed remotely from the client. Once the user verifies that the contract document has been successfully scanned, the VCM process creates a header message for the scanned document. The header file contains information describing the identity of the organization and department owning the contract; a document description, including a unique file identifier for the image data; file size; VCM client identity and location information; and the location of the file on the client machine. All data entered by the user to identify the specific document is verified on the display screen. This information is then sent to the host as a header file (step 510). The user will then click on the “Send to Server” button. The header message to the VCM web service is formatted as a XML document. All transactions between the VCM host server and VCM client are handled as Hypertext Transfer Protocol over Secure socket layer (HTTPS) messages. Transmitting the header message to the VCM host server initiates the image download process.

The VCM host receives the header information (step 512) and authenticates the message. As previously mentioned, the VCM host (alternatively referred to herein as the “VCM web service”) may manage vendor contracts for both its owner-organization and for other organizations as a fee-based management service. In response, the VCM host prepares for this upload by allocating file space and creating a directory for the image data in the resource area allocated to the organization identified in the header message (step 514). As a practical matter, the VCM process allocates temporary disk space for the upload prior to transferring the uploaded image file into the permanently allocated space for the organization. The host server then formats and replies to the client confirming that the download is ready to begin (step 516).

An interactive session between the VCM Document Manager ActiveX component and the web service residing at the VCM host will continue until all pages of the document have been transmitted to the VCM host server. The session will end only after the VCM document manager sends a specific trailer message to the web service signifying that the transfer is complete and the web service will then process the images.

Returning now to FIG. 5A, the client receives a confirmation (step 518). If the upload is denied by the VCM host, then the process ends and an error message is displayed to the user on the VCM client. If there are no errors, the VCM client begins disassembling the scanned images into BIN.BASE64 XML datatype segments (i.e., oElement.dataType=bin.base64 (step 520)) which are a maximum of 16K in length.

The bin.base64 standard and base64 command line utility are merely exemplary standards used herein for the providing exemplary embodiments of an operational application. More importantly, the MIME (Multipurpose Internet Mail Extensions) specification, as well understood in the relevant art, defines a mechanism for encoding arbitrary binary information for transmission over a network, while its successor MIME::Base64 specification involves a much more secure means for the encoding and decoding of base64 strings designed to represent arbitrary sequences of octets. The MIME::Base64 specification defines a 65-character subset of “(,), [,], A-Z, a-z, 0-9, +, / and=” of US-ASCII for transporting data. In any case, the client inserts the 16K bin.base64 segment into an XML document and sends that document to the web service of the VCM host (step 522).

Turning now to FIG. 5B, the initial uploaded XML document containing the 16K MIME datatype segment is received by the VCM server host (step 524) and then conferred back into a binary-type image segment (step 526). The data is now in its native (raw) form that can be written to disk (an exemplary image file format is the TIF format). Next, the VCM process writes the image segment to the file, appending it behind any data segments that were previously received by the host (step 528). The newly written data segment is tested for a successful completion of the write to disk operation using, for example, block tests (step 530), If an error encountered in the upload is aborted, an error code is set (step 532), and the error code is included in a formatted confirmation response message (step 536) which the VCM sends back to client (step 538). If the write to disk operation is successful no error was encountered during the write operation, the VCM sets a zero error code signaling the client that the upload segment was complete and sends the formatted confirmation response message to the client (steps 536 and 538).

The client receives the confirmation response message from the web service (step 540) and checks the message processing for a processing error code (step 542). If an error occurs at the VCM host, then an error message is produced that notifies the user that the upload has been aborted (step 558). The upload process must then be reinitiated from step 510. If the message does not contain an error code (step 542), then the VCM client performs a check to determine if more image segments are to be sent (step 544). If the contract image document has not been completely transmitted to the VCM host, the VCM client continues disassembling the scanned images into BIN.BASE64 XML datatype segments (step 520), inserting them in an XML document which is sent to the VCM host via the web service (step 522). If, on the other hand, all the BASE64 segments have been successfully received by the host, then the VCM client formats and sends the trailer portion of the upload (step 546). The trailer provides information to be used by the web service on the server to verify that the upload is complete.

At this point in the process, the VCM host server receives the trailer, checks the number of bytes transferred with what was specified in the trailer message to insure that the entire transmission was received (step 548), and then prepares the file for additional processing requests from the client (step 550). The assembled image file is also moved to its permanent storage area, which was previously allocated to the entity which created the image. As mentioned above, that file will utilize a VCM host resource dedicated to the organization, department and/or other indexing criteria as provided by the user who scanned the document. The VCM host sends a confirmation to the user confirming the receipt of the document images (step 552) and then checks the information in the trailer to determine if the user requested any other process, specifically OCR-ing the image document (step 562). If requested, the image document is added to the OCR processing queue for the OCR server (step 564). If OCR processing was not requested, then the VCM process excesses are VCM processing parameters for the organization from the organization's resource database to determine if someone other than the user has requested OCR processing for this particular image (or the organization has requested OCR processing for each of its contracts)(step 566). The VCM process determines from these parameters if OCR processing is necessary (step 568); if not, the process ends. Otherwise, if the OCR is specified by the parameters, then a priority level is determined from the organization parameters (step 570) adds the image to the OCR processing queue (step 572). In accordance with one exemplary embodiments of the present invention, all documents are OCR-ed for indexing purposes. However, not all OCR-ed documents are individually inspected for OCR accuracy. If a document is to be inspected, then it is placed into a queue for “clean up” processing. Server side VCM processing then ends.

Returning again to FIG. 5A and the client side of the VCM process for acquiring a contract document image, transferring it to the VCM host and automated OCR processing, the VCM client receives the trailer confirmation message from the VCM server host (step 554) and determines from the message whether or not the image was successfully transferred (step 556). If not, the process again reverts to step 558 indicating that an error occurred in transmission and informs the user that the upload had been aborted. The user should then reinitiate the scanning process from step 510. If the upload was successful, the client displays an upload complete message to the user and the processing ends at the client side.

An authorized user from an organization has the ability to set up notifications or event alerts for the contracts for the organization. The VCM process proactively monitors events in administering contracts. There are many events associated with a contract and corporate policy that would warrant an alert being issued by the VCM process. Examples of such events include the occurrence of contract dates such as renewal, termination, cost increases or reviews. Policy could also dictate events such as reviews and budget calculations. The VCM allows users to set up as many event alerts as they desire for contracts. The VCM also provides a configurable escalation feature that notifies the next person in line of control if a contract alert has not been actively closed within a specific time frame.

When an alert is created, it is entered into a table that is monitored by a continuously running task that checks the table for expired alerts. Each alert expires as configured by the user entering the alert. A user provides the following information when entering an alert. Who is the responsible party in the organization for the contract to whom the alert notification should be sent? This could be one or more email addresses for people that need to be notified and are able to close the alert. Next, the subject of the alert is included. This always begins with reference information about the contract and its ID; it also allows the user to expand on the subject. There are additional text fields for allowing the user to input instructions and next actions into the alert for the review of the recipients. The user then defines an escalation path which is usually determined by the manager of the contract and allows the user to set the beginning point of the escalation. Next, a begin date for the first alert and the frequency for sending alert notifications should take place is entered. The alert notification process will be closed in response to the receipt of an acknowledgment from the responsible party, or the occurrence of a superseding event (i.e., a date on which the escalation process is invoked). Thus, the final information necessary for setting up an event alert notification is specifying an end date (or time period) for the escalation to occur if the alert has not been closed.

The VCM system will place the initial event in the alert queue for processing. The VCM Alert Manager will continuously check this queue for expiring alerts. Once this newly created alert has expired, the VCM Manager will pick it up from the queue for processing. The alert will be sent to the recipients specified at the time of creation and another alert will be entered into the queue using the frequency period as the rule if the end date is greater than the next alert date. If the end date is less than the calculated next alert date, then the end date is used as the alert date. Once one the recipients closes the alert, the entry in the alert will be deleted. This ends the cycle of notifications for this alert. If the alert is not closed and the next alert expires, then the process begins again.

The VCM Alert Manager will check for escalation based upon the alert date and the alert end date specified by the user. If the alert date is equal to or greater than the alert end date, then escalation processing will occur. The alert is sent to the first person specified in the escalation line of control and another alert is scheduled to be sent in a specified number of days. This occurs until the top of the line of control is reached and is sent an alert every three days. This occurs until the alert is closed.

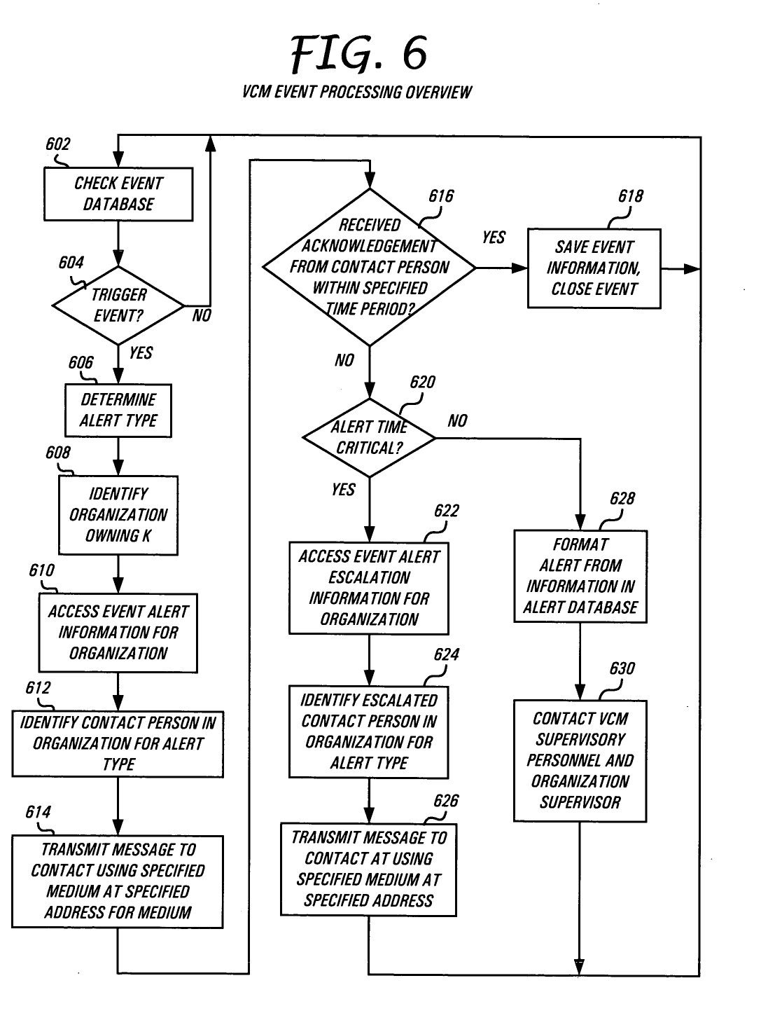

FIG. 6 is a flowchart depicting a vendor contract management event alert processing method in accordance with an exemplary embodiment of the present invention. As discussed above with respect to FIGS. 1 and 3, alerts may be based on terms and conditions in a contract, and organization's rules and policies, or the VCM's internal event processing rules. In any case, alerts are processed by the VCM alert manager in essentially the same manner, regardless of the source for the alert. This can be appreciated from the flowchart depicted in FIG. 6 where the event alert processing method is an iterative process continually running in the background. Process begins with the VCM alert manager checking the event database for expiring alerts (step 602). Check is made for any trigger events (step 604). If the VCM alert manager finds no expiring alerts, the process iterates back to the monitoring step 602. If a trigger event has occurred, the VCM alert manager determines the alert type (step 606). The VCM alert manager identifies the organization owning the contract associated with the alert (step 608) and accesses the event alert information for the organization (i.e., policy and rules regarding the contract and specific type of event alert)(step 610).

Next, the responsible party in the organization for the alert type and contract is identified (step 612) and an alert notification is transmitted to the contact person using a specified communication medium and address for the contact (step 614). At this point, the VCM alert manager may create a new alert based on the notification and the escalation date (or time period) specified for the contract.

The alert event will be closed only by the contact person acknowledging receipt of the notification; otherwise, the alert will expire, thus invoking the escalation process. If the VCM alert manager receives an acknowledgment from the contact person within the specified time period (step 616), the acknowledgement information is saved with the event information and the event is then closed (step 618). The VCM alert event process then returns to step 602.

At the expiration of the alert (i.e., the end of the time period for acknowledgment), the VCM alert manager determines if the alert time is critical (step 620). If alert time is critical and the time period for acknowledging the notification has passed, the VCM alert manager accesses the event alert escalation information for the alert (step 622). Typically, the alert escalation information is specified by the user when creating the alert; however, the escalation information may instead be associated with the contract or with the organization owning the contract. In any case, the escalated contact person is identified (step 624) and an alert notification is transmitted to the escalated contact person using a specified communication medium and address for the contact (step 626). The VCM alert manager may then create still another new alert based on the escalation notification and the escalation date (or time period) specified for the contract. Here again, the alert is closed only upon receipt of an acknowledgment from the escalated contact person.

Returning now to step 620, the escalation process will not be invoked at the expiration of any alert which does not specify notification escalation. Therefore, if the original alert expires without the VCM manager receiving an acknowledgment, the alert information is formatted from the alert database (step 628), and VCM supervisory personnel are contacted along with a default contact person with the organization (step 628). The VCM event processing method again reverts to the monitoring step 602.

In addition to setting contract parameter values for event alert notification, the entire context of the contract may be extracted and indexed into an organization's contract document textual database. This requires that the contract be OCR-ed as described briefly above with regard to FIG. 5B. Briefly, the VCM OCR processing of a contract document proceeds as follows. The VCM OCR queue manager checks the OCR queue every minute for new documents to OCR. When a Queue entry is found, it will copy the document images(s) to the staging queue for the OCR server to process. It checks a specific directory for work, performs the OCR and then stores the results in another directory for manual review, if required.

A VCM indexing checker then checks the output directory for documents that need to be indexed. Since all documents are indexed, regardless of whether or not they are manually reviewed, a copy will be made of the document created by the OCR server and saved to the directory on the FileStore that was specifically created for the storage of this document (note: the directory location stores all work product created for this document, including the images). The VCM index checker will then insert a row into the VCM index queue notifying the VCM index manager that the document needs to be indexed. The VCM index manager takes the output from the OCR process (a text file) and indexes each word in the document with the exception of common non essential words as defined by the organization (stop words). These words are usually “if,” “for,” “the” and other words that do not need to be indexed.

The VCM OCR review manager then checks for documents that need manual review. Each document is checked against the parameters for the organization and user requests to determine if OCR review and clean up are necessary. A row is added to the OCR review queue to manage the review process. Personnel will check documents out of this queue and manually correct the OCR errors in the document. When finished, the document will be checked back in and a row is inserted into the VCM index queue so the document can be re-indexed. Since the OCR and indexing processes are automatic, the user document could be indexed and available for search within minutes, depending upon backlogs at the OCR server. This enables other users of the VCM system to search for words or phrases of the newly entered document within minutes.

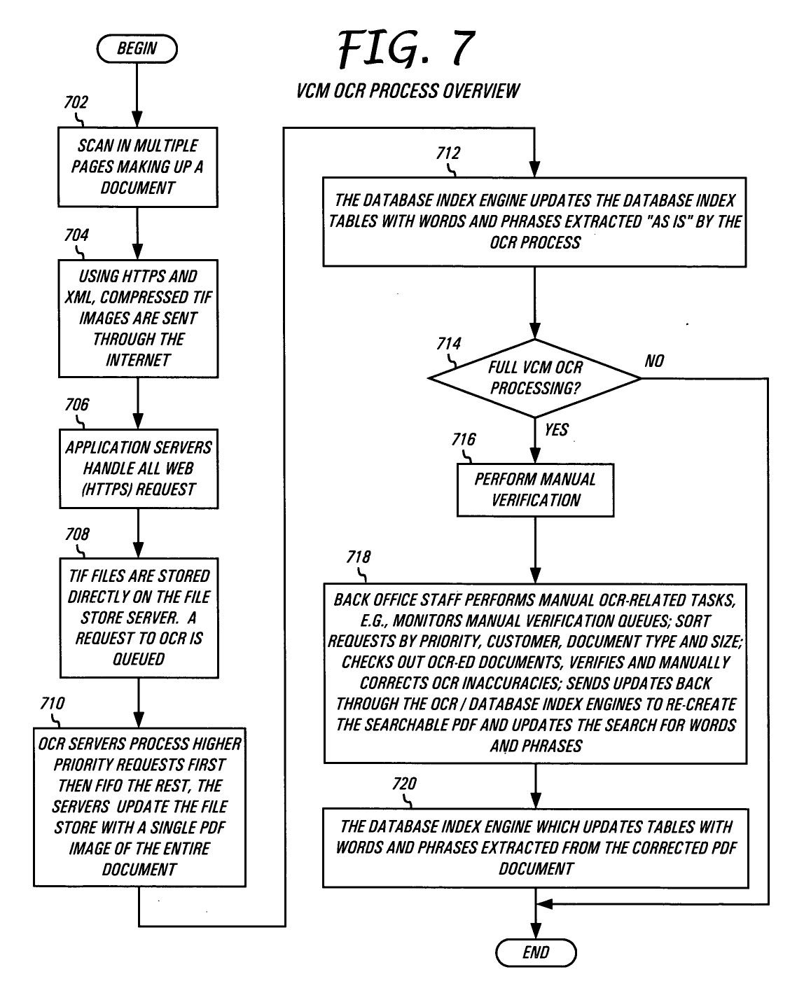

FIG. 7 is a flowchart depicting a vendor contract management optical character recognition and indexing method in accordance with an exemplary embodiment of the present invention. The VCM OCR process begins with the user scanning in multiple pages of the contract document (step 702) and then transmitting the scanned and compressed data in an XML document using HTTPS (step 704), as described above with regard to FIG. 5A. The messages are received at the VCM host as described above with regard to FIG. 5B (step 706), and the files are stored on a file store server for further processing (step 708). In accordance with the exemplary embodiment of the present invention, each scanned document transmitted to the VCM host is OCR-ed, regardless of whether or not the organization requests it. Alternatively, scanned documents received by the VCM host can be OCR-ed only at the organization's request. In accordance was still another exemplary embodiment, all documents received by the VCM host are automatically OCR-ed but not reviewed for OCR accuracy unless the organization requests a manual review of the OCR. In that case, every document received by the VCM host can be indexed into the textual database for searching, even though some documents may contain minor OCR errors.

With regard to either embodiment, the VCM queue manager monitors the OCR queue and selects documents for OCR processing based on priority (step 710). Only priority documents are processed on a first-in, first-out basis. In accordance with an exemplary embodiment of present invention, a textual file (in a searchable document file format such as PDF, DOC, etc.) is appended to the contract document image file containing a single PDF image of the entire contract. Immediately after OCR-ing, the database index engine extracts words and phrases from the PDF file and updates the VCM database index tables (step 712). Stop words such as “a, an, the, of” are excluded from indexing.

Next, the VCM OCR manager determines whether or not the organization requires the full VCM OCR process (step 714). The VCM back office OCR staff monitors the manual verification queues for documents when the owner-organization has requested a manual review of the OCR results, and identifies and corrects the OCR errors (step 716). The cleaned up version of the OCR document may be re-indexed in the VCM index database. Additionally, the back office staff can sort requests by priority, customer, document type and size, check out documents from the queues, verify and correct OCR inaccuracies, and/or tag the image document for additional OCR/database index engines for another pass to recreate another version of the searchable PDF. The staff can also update the search for words and phrases steps 710, 712 and 720 (step 716). Although the searchable textual file may be replaced, the original image file remains intact. Finally, the database index engine extracts words and phrases from the corrected PDF file and updates the VCM index tables (step 720). The VCM OCR-Indexing process then ends.

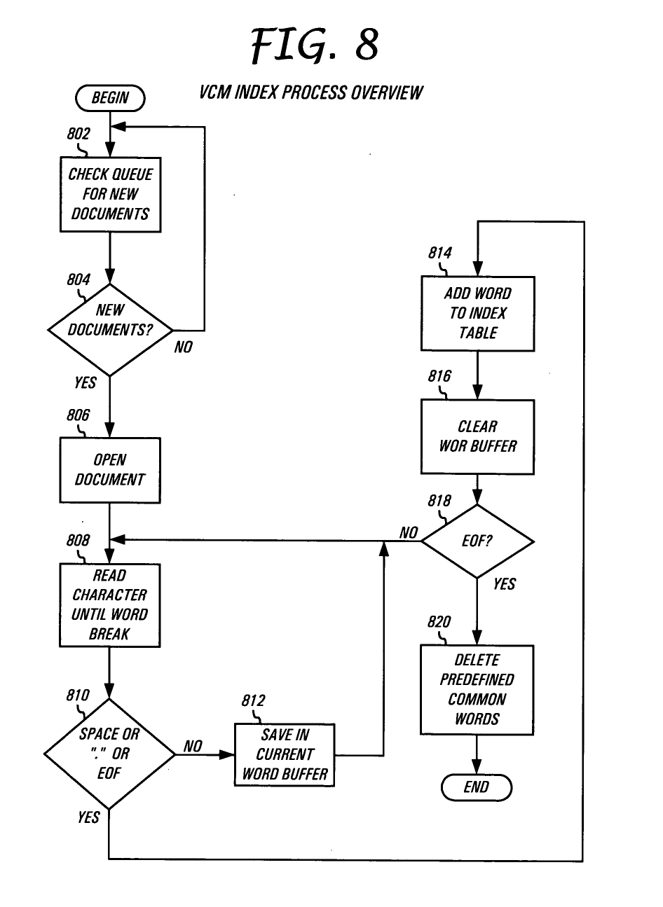

FIG. 8 is a flowchart depicting the indexing and updating methodology employed by the VCM database index engine in accordance with an exemplary embodiment of the present invention. Process begins by checking the queue for new documents (steps 802 and 804), and opening the highest priority documents in the queue (step 806). At this point, the documents have been converted into the textual format such as a PDF or DOC file format. The VCM database index engine then reads the next character in the textual document (step 808) and determines if it has reached a word break (step 812). If not, the current character is saved with the previously read character(s) (step 812) and the indexing process reverts to step 808 for another character until a space, period (“.”) or EOF code is reached (step 810). Once a space, period (“.”) or EOF code is encountered, the VCM database index engine adds the word in the buffer to the database index table (step 814) and clears the word buffer (step 816). The VCM database index engine then determines if the last word read was an EOF (step 818); if not, the process reverts, once again, to step 808 for another character until a space, period (“.”) or EOF code is reached (step 810). Returning to step 818, when an EOF has been encountered for the document, the VCM database index engine reviews the index table for common words (e.g., stop words such as “a,” “an,” 'and,” “the,” “or,” in addition to any predefined stop words) (step 820). The edited index table can then be included in the VCM index database for indexing the current contract document. The indexing process then ends.

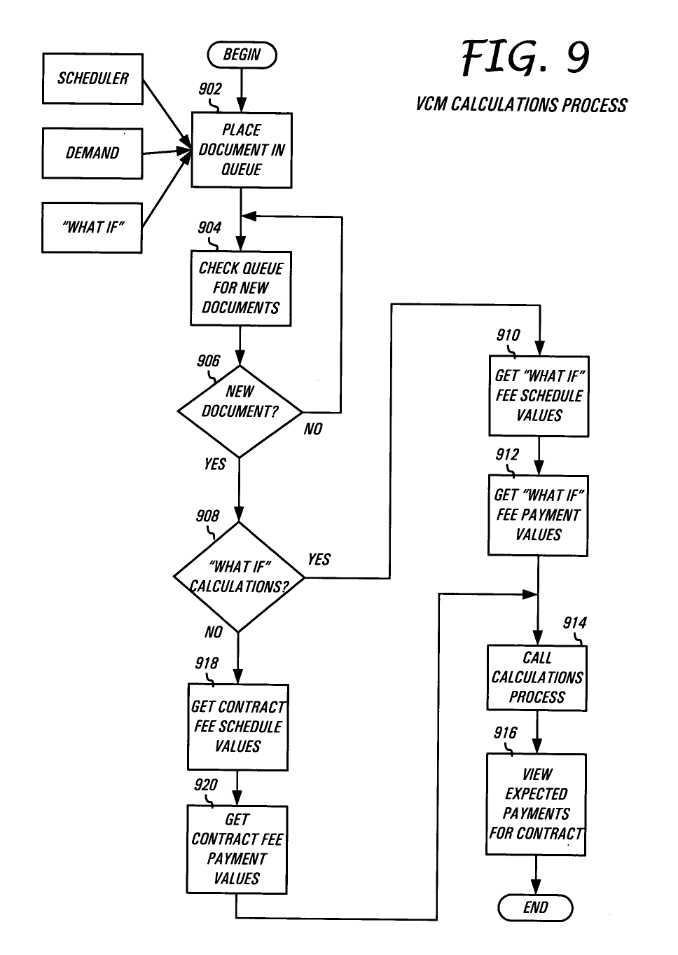

Another function of the VCM system is for managing and forecasting financial obligations arising from the contract parameters. As shown in FIG. 1, the VCM system includes calculations module 116 for calculating fees in the furtherance of managing enterprise contracts and forecasting contract related events which may impact the enterprise. FIG. 9 is a flowchart depicting a vendor contract management calculations method for generating a list is scheduled expected payments for a given fiscal period in accordance with an exemplary embodiment of the present invention. The process begins by the placement of a document in the calculations queue (step 902). A contract document may be placed in the queue by various VCM features. For instance, the VCM application allows the user to select active contracts for calculation and by using the VCM calculations demand feature. This places the selected contracts in the calculation queue. Alternatively, contracts can be scheduled by the user to run on specific time frames (monthly, bi-weekly, weekly, daily). The user may schedule one or more contract documents for calculations processing using the scheduler function (the scheduler is depicted in FIG. 1 as scheduler 118). Still another means for placing contract documents in the queue for processing is by using the “what if” feature and specifying a contract. The VCMNetStart program continually checks the various queues (Notification, Auto Renewal and Calculations.) (step 904). If VCMNetStart detects contracts in the calculation queue, it calls the calculations program (step 906). Usually, the calculations process generates a view of expected payments for the contract based on the contract parameter values. However, calculations process may also make a “what if” view of the expected payments for the contract. Using the “what if” scenario, the calculations process does not use the contract parameter values. Since the parametric data used by the calculations process in a “what if” scenario is different from the contract parameter values the VCM application first checks to determine if a “what if” calculation is being made (step 908). If a “what if” calculation is to be made for the contract, the calculations process accesses “what if” fee schedule values input by the user (step 910). Additionally, the calculations process accesses “what if” fee payment values input by the user for making the calculations (step 912). The calculations process then executes (step 914) and generates a list of expected payments for the contract using the “what if” fee payment and fee schedule values (step 916). After viewing and expected payment results the user may go back and adjust either the “what if” fee schedule values or the “what if” fee payment values and then reexecutes the calculations process. The process then ends.

If a “what if” calculation is not being made for the contract, the calculations process retrieves fee schedule values and fee payment values from the contract (steps 918 and 920). In this past, the calculations process executes on the fee schedule values and the payment values from contract (step 914). The calculations process generates a list of expected payments for the contract using the contract's fee payment and fee schedule values (step 916). Calculations are based on the contract information entered into VCM. If a contract is set to be renewed, and price increase, payment adjustment, etc. is formulated during calculation. If desired, the user can now generate a series of “what if” calculations for comparison with the expected payments for the contract.

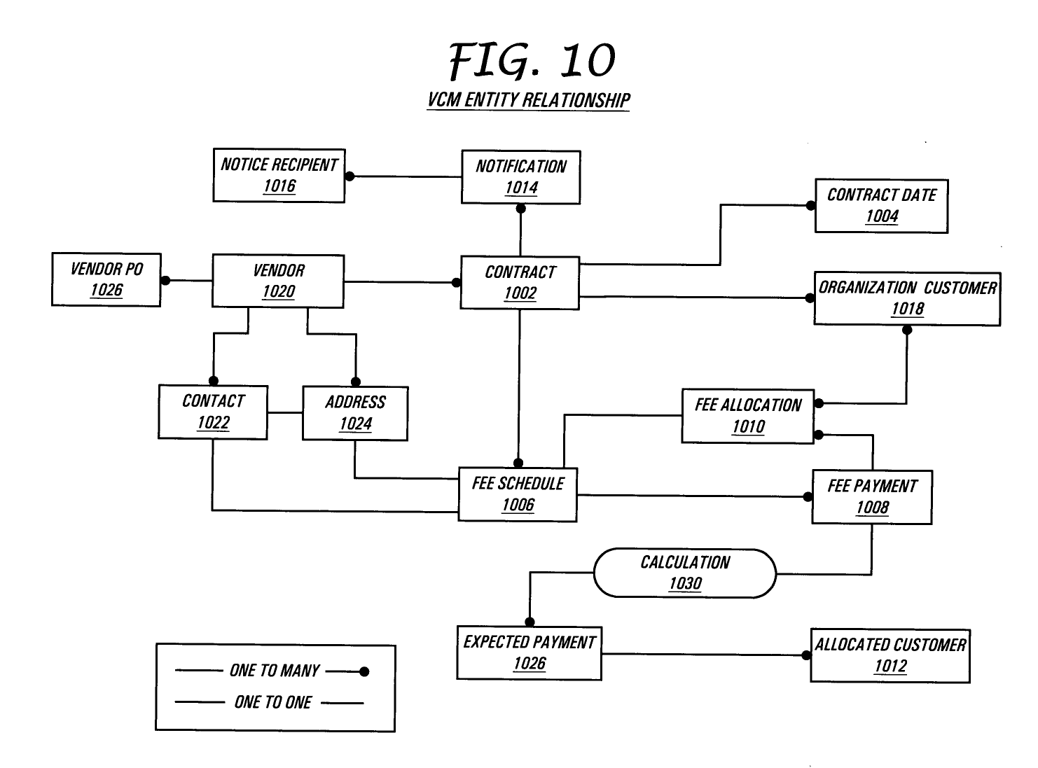

FIG. 10 is a diagram depicting the relationships between VCM entities in accordance with an exemplary embodiment of the present invention. These VCM relationships formed the basis of the aspects of vendor contract management discussed in the preceding pages. It should, however, be apparent that each of these entities he is a compilation of the VCM parametric values. The parametric values for these entities are contained within tabular structures, some examples of which are illustrated below.

Contract Related Tables

TABLE
Contract 1002: Cont (C1)
Columns

| Name | Type | Size | Description |
|---|---|---|---|
| ContID | Varchar | 12 | System Generated ID for the contract |
| VendID | Varchar | 12 | ID of the vendor on the contract |
| ContNbr | Varchar | 30 | Original Contract Number |
| Descr | Varchar | 255 | Description of the Contract |
| Status | Varchar | 12 | Identifier for the status of the contract |
| ContType | Varchar | 12 | Identifier for the type of contract. |

TABLE
Contract Dates 1004: ContDates (C2)
Columns

| Name | Type | Size | Description |
|---|---|---|---|
| ContID | Varchar | 12 | Contract ID |
| ContDateID | Varchar | 12 | System Generated ID for the date |
| | | | entry |
| ContDateType | Varchar | 2 | Identifier for the type of date entry |
| | | | e.g. Contract Start Date, Contract |
| | | | End Date, etc. |
| ContDate | DateTime | | Date of the entry (mm/dd/yyyy) |

TABLE
Fee Schedule 1006: FeeSched (C3)
Columns

| Name | Type | Size | Description |
|---|---|---|---|
| ContID | Varchar | 12 | Contract ID |
| FeeSchedID | Varchar | 12 | System Generated ID for the fee |
| | | | schedule |
| FeeSchedType | Varchar | 12 | Identifier for the type of the Fee |
| | | | Schedule e.g. Software License, |
| | | | Software Maintenance, Hardware |
| | | | Lease, etc. |
| Descr | Varchar | 255 | Free format description of the fee |
| FullAmt | Currency | | Full Amount of the fee schedule |
| Status | Varchar | 12 | Identifier for the status of the fee |
| PaytAddr | Varchar | 12 | Location where the payment needs |
| | | | to be sent |
| PaytContc | Varchar | 12 | Contact to whom the payment is |
| | | | sent |
| PONbr | Varchar | 12 | Associated Purchase Order number |
| PaidInAdvncFlag | SmallInt | | Paid in Advance indicator |
| AdjusFlag | SmallInt | | Subject to adjustment indicator |
| AdjusNtceReq | SmallInt | | Adjustment Notice Required |
| | | | indicator |
| AdjusNbrDays | Integer | | Number of days to receive the |
| | | | notice |
| AdjusPcnt | Numeric | (3, 2) | If <=0 apply CPI, otherwise apply |
| | | | the entered percentage |
| AdjusAmt | Currency | | If this amount is specified, this is |
| | | | the amount to be used as |
| | | | adjustment |
| RenwlFlag | SmallInt | | Renewal Indicator |
| Changed | SmallInt | | Indicator to show that the Fee |
| | | | Schedule has changed and needs to |
| | | | be recalculated |
| SerNbr | Varchar | 30 | If the fee schedule is associated |
| | | | to an equipment, this is the serial |
| | | | number of it |

TABLE
Fee Payment 1008: FeePayt (C4)
Columns

| Name | Type | Size | Description |
|---|---|---|---|
| ContID | Varchar | 12 | Contract ID |
| FeeSchedID | Varchar | 12 | Fee Schedule ID |
| FeePaytID | Varchar | 12 | System Generated Fee Payment ID |
| FeePaytType | Varchar | 12 | Identifier for the type of the Fee |
| | | | Payment, e.g. One time, monthly, |
| | | | biweekly, quarterly, etc. |
| PaytAmt | Currency | | Amount of the fee payment |
| PaytStartDate | DateTime | | Scheduled start date for payment |
| PaytEndDate | DateTime | | Schedule end date for payment |

TABLE
Fee Allocation 1010: FeeAlloc (C5)
Columns

| Name | Type | Size | Description |
|---|---|---|---|
| ContID | Varchar | 12 | Contract ID |
| FeeAllocID | Varchar | 12 | System Generated ID for the |
| | | | fee allocation entry |
| FeeSchedID | Varchar | 12 | Fee Schedule ID |
| FeePaytFlag | SmallInt | | Flag to indicate if this |
| | | | allocation is for the whole fee |
| | | | schedule or for a particular |
| | | | payment |
| FeePaytID | Varchar | 12 | Fee Payment ID, in case this |
| | | | allocation is for a specific |
| | | | payment |
| FeeAllocAmt | Currency | | Amount to be allocated |
| FeeAllocType | SmallInt | | Flag to indicate the type of |
| | | | allocation: by amount or by |
| | | | percentage |
| AllocFisclYearMonth | Int | | Fiscal period when the |
| | | | amount will be billed to the |
| | | | customers |

TABLE
Fee Allocation Customer 1012: FeeAllocCust (C6)
Columns

| Name | Type | Size | Description |
|---|---|---|---|
| FeeAllocID | Varchar | 12 | Fee Allocation ID |
| CustNbr | Varchar | 12 | accounting application Customer |
| | | | Number |
| AllocAmt | Currency | | Amount allocated to the organization |
| | | | Customer |

TABLE
Contract Notification 1014: ContNot (C7)
Columns

| Name | Type | Size | Description |
|---|---|---|---|
| ContID | Varchar | 12 | Contract ID |
| NotID | Varchar | 12 | System Generated ID for the notification |
| | | | entry |
| StartDate | DateTime | | Date when the notification will start to |
| | | | be sent |
| EndDate | DateTime | | Date when the notification will stop |
| Freq | Varchar | 12 | Notification frequency: weekly, monthly, |
| | | | etc. |
| NotText | Varchar | 255 | Text of the notification |

TABLE
Recipients 1016: Recpt (C8)
Columns

| Name | Type | Size | Description |
|---|---|---|---|
| ContID | Varchar | 12 | Contract ID |
| NotID | Varchar | 12 | Notification ID |
| RecptEMail | Varchar | 50 | Recipient e-mail |

Table: Contract Organization Customer 1018: ContCust (C9)
Columns

| Name | Type | Size | Description |
|---|---|---|---|
| ContID | Varchar | 12 | Contract ID |
| CustNbr | Varchar | 12 | accounting application Customer Number |

Table: Vendor 1020: Vend (V1)
Columns

| Name | Type | Size | Description |
|---|---|---|---|
| VendID | Varchar | 12 | System Generated ID for the vendor |
| Name | Varchar | 25 | Name of the vendor |

Table: Contact 1022: Cntct (V2)
Columns

| Name | Type | Size | Description |
|---|---|---|---|
| CntctID | Varchar | 12 | System generated Contact ID |
| VendID | Varchar | 12 | Vendor ID |
| FirstName | Varchar | 15 | First Name of the contact |
| LastName | Varchar | 20 | Last name of the contact |
| MidName | Varchar | 1 | Middle Initial of the contact |
| SufName | Varchar | 4 | Suffix added to the contact name, |
| | | | e.g. Jr., Sr., etc. |
| Title | Varchar | 4 | Title added to the contact name, |
| | | | e.g. Mr., Miss, etc. |
| LoctnID | Varchar | 30 | Location ID, indicates the address |
| | | | related to the contact |
| PhoneNbr | Varchar | 20 | Phone Number, enter as free format |
| FaxNbr | Varchar | 20 | Fax Number, enter as free format |
| CntctTitle | Varchar | 30 | Official title of the contact within the |
| | | | vendor |
| CntctType | Varchar | 1 | Type of the contact, e.g. (I)nvoice, |
| | | | (A)ccount payable, (U)ser, etc. |
| Resp | Varchar | 60 | Description of the responsibilities |
| | | | of the contact |
| AdminName | Varchar | 60 | Department Name |
| AdminPhoneNbr | Varchar | 20 | Department phone number |
| AdminFaxNbr | Varchar | 20 | Department fax number |

Table: Address 1024: Addr (V3)
Columns

| Name | Type | Size | Description |
|---|---|---|---|
| VendID | Varchar | 12 | Vendor ID |
| LoctnID | Varchar | 12 | Identifier of the address |
| AddrLine1 | Varchar | 30 | Address line 1 |
| AddrLine2 | Varchar | 30 | Address line 2 |
| AddrLine3 | Varchar | 30 | Address line 3 |
| AddrLine4 | Varchar | 30 | Address line 4 |
| AddrLine5 | Varchar | 30 | Address line 5 |
| City | Varchar | 25 | City |
| State | Varchar | 2 | Abbreviation of the state |
| ZIPCode | Varchar | 10 | Postal Code |
| Cntry | Varchar | 20 | Country |
| IntAddr | SmallInt | | International address indicator |

Table: Vendor Purchase Order 1026: VendPO (V4)
Columns

| Name | Type | Size | Description |
|---|---|---|---|
| VendID | Varchar | 12 | Vendor ID |
| PONbr | Varchar | 12 | Purchase Order Number |
| Amt | Currency | | Full amount of the purchase order |
| Descr | Varchar | 255 | Purchase order description |
| ApprvSign1 | Varchar | 30 | Employee 1 that approved the PO |
| ApprvSign2 | Varchar | 30 | Employee 2 that approved the PO |
| ApprvSign3 | Varchar | 30 | Employee 3 that approved the PO |

Table: Expected Payment 1028: ExptPayt (EP1)
Columns

| Name | Type | Size | Description |
|---|---|---|---|
| ContID | Varchar | 12 | Contract ID |
| FeeSchedID | Varchar | 12 | Fee Schedule ID |
| FeePaytID | Varchar | 12 | Fee payment ID |
| CalcDate | DateTime | | Calculation date |
| PaytDate | DateTime | | Expected Payment Date |
| PaytAmt | Currency | | Expected payment amount |
| ActualPaytDate | DateTime | | Actual payment date |
| ActualPaytAmt | Currency | | Actual payment amount |
| InvceNbr | Varchar | 15 | Vendor Invoice Number |
| Rebill | SmallInt | | Flag to indicate whether this |
| | | | payment will be billed back to the |
| | | | organization customers |
| RebillYearMonth | Integer | | Fiscal period when this amount |
| | | | will be billed back to the |
| | | | organization customers, |
| | | | (Format: yyyymm) |
| BillAmt | Currency | | Amount billed |
| Reconld | SmallInt | | Flag to indicate if this payment has |
| | | | been reconciled against the |
| | | | invoice |
| ReconldDate | DateTime | | Reconciliation date |

What is claimed is:

1. A method for managing contract documents over a network comprising:
receiving a document image from an organization, said document image being an image of a contract document;
storing the document image in a contract document image database;
analyzing the contract document for any of a plurality contract parameters;
obtaining a parametric value for each of a plurality contract parameters contained in the contract document;
determining an identity and alert information of a contact entity for at least one of the plurality contract parameters contained in the contract document;
indexing, to a contract identifier for the contract document, each of the plurality contract parameters contained in the contract document, the parametric value for each of a plurality contract parameters contained in the contract document, and, the identity and alert information for the contract entity for the at least one of the plurality contract parameters contained in the contract document;
storing, in a contract database, data relating to each the contract identifier for the contract document, the plurality contract parameters contained in the contract document, the parametric value for each of a plurality contract parameters contained in the contract document, and, the identity and alert information for a contract entity for the at least one of the plurality contract parameters contained in the contract document;
receiving an event notification;
determining which of the plurality contract parameters relate to the event;
identifying one or more contract documents in the contract database having a contract parameter relating to the event;
comparing the event notification with the parametric value for each of the plurality contract parameters contained in the identified one or more contract documents;
determining whether an event alert is to be issued based on the comparison of the event notification to the parametric value;
identifying a contract entity for contract parameter relating to the event; and
issuing an alert to the identified contract entity.

2. The method recited in claim 1 above, wherein analyzing the contract document for any of a plurality contract parameters is performed locally.

3. The method recited in claim 1 above, wherein analyzing the contract document for any of a plurality contract parameters is performed remotely by the organization.

4. The method recited in claim 1 above, wherein the parametric value for each of a plurality contract parameters contained in the contract document is contained in the contract document.

5. The method recited in claim 1 above, wherein obtaining a parametric value for each of a plurality contract parameters contained in the contract document further comprises:
identifying organization policy relating to any of the plurality contract parameters contained in the contract document;
searching the contract document for an initial parametric value for each of the plurality contract parameters;
comparing organization policy relating to any of the plurality contract parameters contained in the contract document with an initial parametric value from the contract document corresponding to the organization policy;
using the initial parametric value as the parametric value for a contract parameter unless, the contract document does not contain an initial parametric value for the contract parametric, or, the initial parametric value from the contract document conflicts with the organization policy relating to the contract parameter; and
determining the parametric value for a contract parameter from the organization policy relating to the contract parameter unless the contract document contains an initial parametric value for the contract parametric that does not conflict with the organization policy relating to the contract parameter.

6. The method recited in claim 1 above further comprises:
assembling a textual contract document from the contract document image; and
storing the textual contract document for the contract document in a textual contract document database.

7. The method recited in claim 6 above, wherein the textual contract document is assembled locally.

8. The method recited in claim 6 above, wherein the textual contract document is assembled remotely by the organization.

9. The method recited in claim 6 above, wherein storing the textual contract document for the contract document in a textual contract document database further comprises:
indexing the textual contract document for the contract document to one of the contract identifier for the contract document, at least one of the plurality contract parameters contained in the contract document, at least one keyword, and, at least one of the parametric values a plurality contract parameters contained in the contract document.

10. The method recited in claim 9 above, further comprises:
searching the textual contract document database using one of a contract identifier, a contract parameter, a keyword, and, a parametric value for a contract parameter.

11. The method recited in claim 1 above, wherein the document image from the organization is received at a secure server.

12. The method recited in claim 1 above, wherein the document image from the organization is created using a portable program standard.

13. The method recited in claim 12 above, wherein the portable program standard is one of ActiveX, Java and a programming language designed for use in the distributed environment.

14. The method recited in claim 1 above, wherein the document image from the organization is created in compliance with a markup language standard.

15. The method recited in claim 14 above, wherein the markup language standard is one of an extensible markup language (XML), standard generalized markup language (SGML), and hypertext markup language (HTML).

16. The method recited in claim 1 above, wherein obtaining a parametric value for each of the plurality contract parameters contained in the contract document is performed remotely by the organization.

17. The method recited in claim 1 above, wherein obtaining a parametric value for each of the plurality contract parameters contained in the contract document is performed locally.

18. The method recited in claim 1 above, wherein receiving a document image from an organization, said document image being an image of a contract document, further comprises:
transmitting portable document imagining programming instructions for controlling document imaging;
remotely executing the portable document imaging programming instructions;
remotely creating a document image of the contract document using a predetermined imaging information format;
remotely storing the document image of the contract document in the imaging information format;
remotely transforming the document image in the imaging information format to transport-specific information; and
remotely transmitting the transport-specific information for the document image.

19. The method recited in claim 18 above, further comprises:
transforming imaging information from the transport-specific information to imaging information format.

20. The method recited in claim 1 above, wherein receiving a document image from an organization, said document image being an image of a contract document, further comprises:
receiving the document image from an organization in as transport-specific information; and
transforming imaging information from the transport-specific information to imaging information format.
